(19) United States
(12) Patent Application Publication
(10) Pub. No.: US 2010/0293478 A1
(43) Pub. Date: Nov. 18, 2010

(54) Interactive learning software

(76) Inventor: Nels Dahlgren, Corrales, NM (US)

Correspondence Address: PEACOCK MYERS, P.C., 201 THIRD STREET, N.W., SUITE 1340, ALBUQUERQUE, NM, 87102, US

(21) Appl. No.: 12/454,262

(22) Filed: May 13, 2009

(51) Int. Cl. G06F 3/01

(52) U.S. Cl. 715/758

(57) ABSTRACT

Disclosed is a fully interactive, Web-based, distance learning software application which helps professionals to prepare for the oral examinations necessary to attain board certification or to achieve other advancement in fields such as medical specialties including anesthesiology, emergency medicine, obstetrics/gynecology, general surgery, radiology, psychiatry and others. The browser-based technology requires no software installation on subscribers' computers, mobile platforms, televisions or set-top boxes; and, gives site-users, by the foregoing means, access from distant and remote locations, to several interactive functions including, but not restricted to, subscriber-to-subscriber (peer-to-peer) live and interactive practice examinations with video-chat capability; subscriber-to-examiner (peer-to-examiner) live and interactive mock examinations with video-chat capability, that can be recorded, stored and downloaded to computers, mobile devices, televisions and set-top boxes at remote and distant locations for later review; subscriber self-test examinations, which allow the subscriber to interactively self-test against a pre-recorded examiner; videos of successful oral exam performances in a mock examination setting, with an onscreen notepad and video controls that allow the subscriber to type in notes and store them; and instructional videos that provide guidelines and insight into various aspects of personal preparation and behavior for oral examinations.

### BACKGROUND OF THE INVENTION

1. Field of the Invention

The present invention relates to a fully interactive, Web-based, distance learning software application which helps professionals to prepare for the oral examinations necessary to attain board certification or to achieve other advancement in fields such as medical specialties including anesthesiology, emergency medicine, obstetrics/gynecology, general surgery, radiology, psychiatry and others. The technology is entirely browser-based and requires no software installation on subscribers' computers, mobile platforms, televisions or set-top boxes. All software is accessed via a Web-browser and served from a central server. It has four interactive components: subscriber-to-subscriber (peer-to-peer) live and interactive practice examinations with video-chat capability; subscriber-to-examiner (peer-to-examiner) live and interactive mock examinations With video-chat capability, that can be recorded, stored and downloaded to computers, mobile devices, televisions and set-top boxes at remote and distant locations; subscriber self-test examinations, which allow the subscriber to interactively self-test against a pre-recorded examiner; and, videos of successful oral exam performances in a mock examination setting, with an onscreen notepad and video controls that allow the subscriber to type in notes and store them. Also included are instructional videos that provide guidelines and insight into various aspects of personal preparation and behavior for oral examinations. Interactive functions are accessed via computers, Webcams, mobile platforms, televisions and set-top boxes from distant and remote locations.

2. Description of the Prior Art

Oral examinations, in addition to written examinations, are required for board certification or advancement in many fields, including medical specialties such as anesthesiology, emergency medicine, obstetrics/gynecology, general surgery, radiology, psychiatry and others, where the ability, based on a learned body of knowledge, to think and respond quickly to rapidly changing conditions is of paramount importance. These oral examinations may be intense, pressurized experiences, with success rewarded by enhanced income, prestige and professional advancement. The existing methods of preparation for these oral examinations include books that describe the method and thought process on which oral examinations are based, DVDs which contain videotaped demonstrations and lectures, DVDs depicting mock examinations, telephone-based services that offer voice-only mock examinations and oral-examination prep seminars that present informational classes and allow attendees to view one or two mock examinations in an auditorium or classroom setting. These methods, which may cost up to several thousand dollars, do not present the subscriber (peer) with opportunity to prepare for oral exams by engaging in unlimited interactive self-tests, practice exams with their peers, or, with certified professionals in their respective fields of endeavor. Alternately, subscribers (peers) studying for the oral exams are reduced to a haphazard approach of asking their local peers to quiz them, or, attempting, often unsuccessfully, to persuade a busy certified professional, such as a board-certified anesthesiologist, to present them with a real-time, face-to-face mock examination. Except for the present invention, there are no oral-examination prep services that offer the subscriber fully interactive peer-to-peer practice exams, peer-to-examiner mock exams or interactive self-tests in a real-time video-chat environment.

### SUMMARY OF THE INVENTION

The present invention relates to a fully interactive, Web-based, distance learning software application which helps professionals to prepare for the oral examinations necessary to attain board certification or to achieve other advancement in fields such as medical specialties including anesthesiology, emergency medicine, obstetrics/gynecology, general surgery, radiology, psychiatry and others. The technology is entirely browser-based and requires no software installation on subscribers' computers, mobile platforms, televisions or set-top boxes. All software is accessed via a Web-browser and served from a central server. It enables peer-to-peer real-time, interactive practice examinations with video-chat capability, connecting participants at distant and remote locations; peer-to-examiner live and interactive mock examinations with video-chat capability that can be recorded, stored and downloaded to both participants at remote and distant locations; and interactive self-test that allow subscribers (peers) to respond to a pre-recorded examiner and download their performance and responses to their own computers for self-assessment from a distant and remote location; and pre-recorded videos of simulated, scripted oral examinations, with interactive note-taking that can be accessed from computers, mobile platforms, televisions and set-top boxes at distant and remote locations.

It is therefore a primary objective of the present invention to provide a Web-based method which will significantly enhance the quality of oral examinations preparation.

It is another objective of the present invention to provide a Web-based method which will meet the need for on-demand, interactive peer-to-peer practice examinations in a video-chat environment with or without outside video-chat services.

It is a further objective of the present invention to provide a Web-based method which will enable on-demand, real-time mock examinations between certified professionals and resident-physicians in a video-chat environment, with recording, storage and distribution of the mock-examinations, with or without outside video-chat services.

It is still another objective of the present invention to provide a Web-based method which will enable the subscriber to self-test in a real-time video-chat environment using a pre-recorded examiner and embedded time clock with or without outside video-chat services.

It is still a further objective of the present invention to provide a Web-based method which offers instructional videos, with interactive note-taking capabilities and on-screen video controls, that depict successful physical behavior and verbiage for passing oral examinations.

These and other objects of the present invention will become apparent to those skilled in this art upon reading the accompanying description, drawings and claims set forth herein.

### BRIEF DESCRIPTION OF THE DRAWINGS

FIG. 1 is an example of the user interface encountered by the subscriber when using a pre-recorded instructional video with note-taking capability, according to the present invention.

FIG. 2 is an example of the user interface encountered by the subscriber when using peer-to-peer video-chat for impromptu practice oral examinations, according to the present invention.

FIG. 3 is an example of the user interface encountered by the subscriber when using a pre-recorded examiner to conduct a self-test, according to the present invention.

FIG. 4 is an example of the user interface encountered by the user when taking a mock examination conducted by a certified professional, such as a board-certified physician, and recorded and stored at the Web site for downloading to both participants, according to the present invention.

FIG. 5 is a schematic view of the technology supporting the pre-recorded instructional video with note-taking capability, according to the present invention.

FIG. 6 is a schematic view of the technology supporting the subscriber-to-subscriber (peer-to-peer) video-chat for impromptu practice oral examination, according to the present invention.

FIG. 7 is a schematic view of the technology supporting the video-chat system for the mock examination conducted by a certified professional, such as a board-certified physician, and recorded and stored at the Web site for downloading to both participants, according to the present invention.

FIG. 8 is a schematic view of the technology supporting the self-test between a pre-recorded examiner and the subscriber, according to the present invention.

### DETAILED DESCRIPTION OF THE INVENTION

The present invention employs four interactive, video-based approaches for oral examination preparation:

The first approach is pre-recorded instructional videos of simulated oral examinations. The present invention offers original, pre-recorded instructional videos or slide presentations, scripted and/or edited by certified professionals, such as board-certified physicians, to ensure highest quality. Using the medical specialty of anesthesiology as an example, each video presents a specific “scenario,” the medical case on which an oral examination is based, with a presenter and two examiners, as actual exams are conducted. Subscribers may interact with these scripted videos. As depicted in FIG. 1, the scenario appears on the subscriber's screen in printed form. The subscriber may outline notes and possible responses and type them into a ‘notepad’ adjacent to the video viewing area. The subscriber then hits a ‘play’ button and the video begins, progressing through a series of questions that develop from the original scenario. The video shows how the presenter (the person taking the test) answered the questions correctly, avoiding traps and leading the examiners into the presenter's areas of strength. The number of scenario-videos varies with each specialty. The videos may vary in length. The videos may show an examiner cutting off or ‘stepping’ on a presenter's answer, much as they do in real practice to keep the exam to a prescribed time. Also, the presenter may be allowed to answer a question in full. To further enhance interactivity, subscribers can pause, rewind, stop and restart a video through on-screen video controls. All scenarios, or root topics, are original and copyrighted by the entity presenting the present invention.

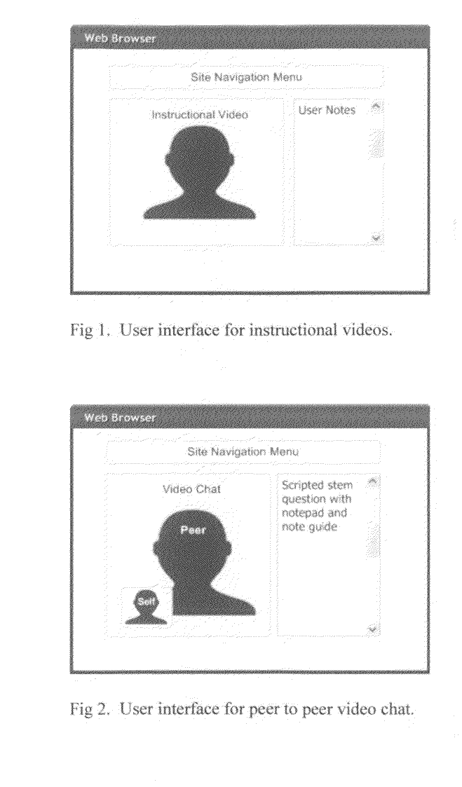

The second approach is the interactive subscriber-to-subscriber (peer-to-peer) practice examination. These examinations take place at the discretion of the subscriber. When a subscriber logs into the Web site, he/she will have the option to video-chat connect with other subscribers who are also logged in. In this interactive, video-chat environment, subscribers can present each other with pre-scripted scenarios and questions provided by the Web site, or present scenarios that they themselves devise. This peer-level practice presents opportunity to experience the oral examination process from both examiner and presenter (examinee) sides. As depicted in FIG. 2, the subscriber will view himself/herself and his/her peer on screen. This video-chat interaction utilizes a fully integrated flash-based video chat service, but may optionally utilize a third party video conferencing application.

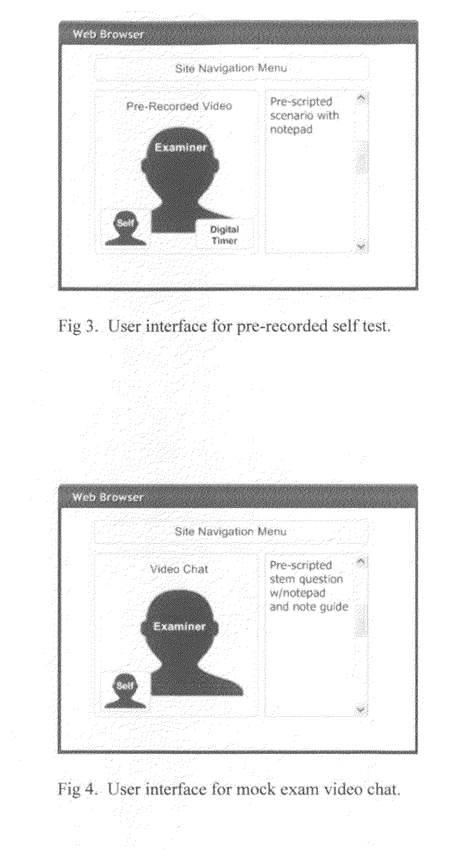

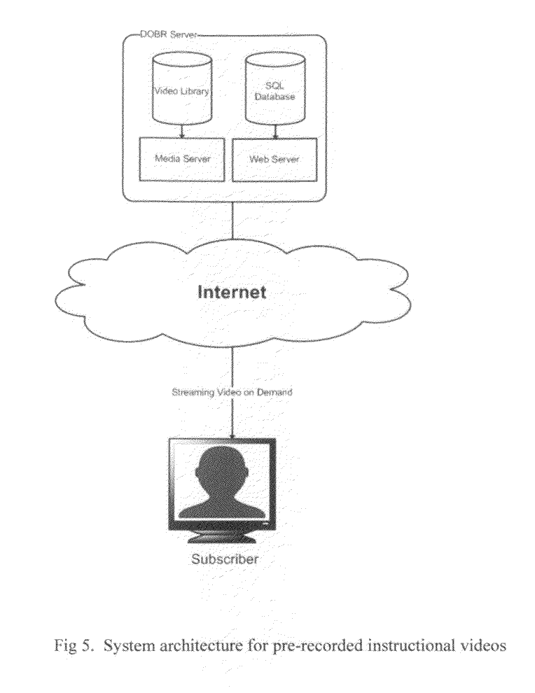

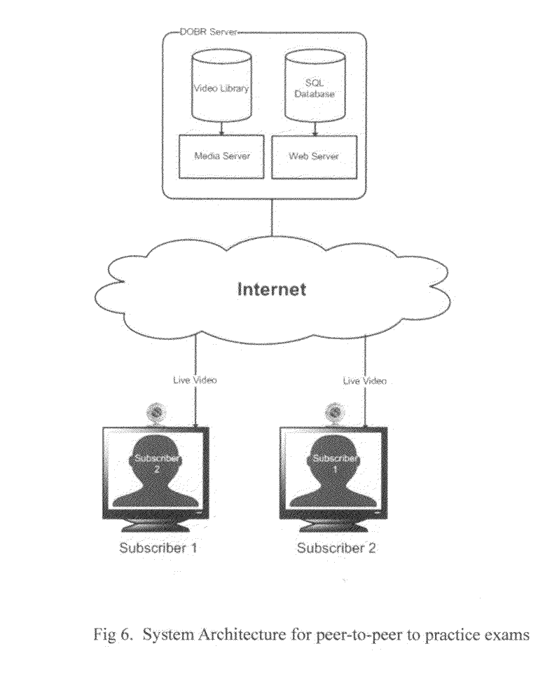

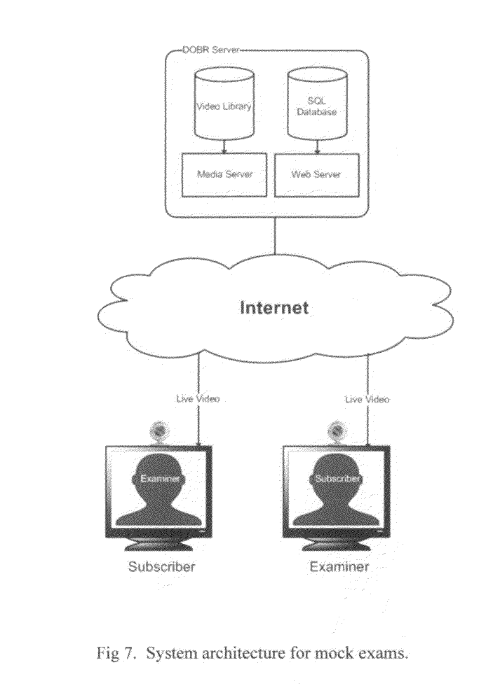

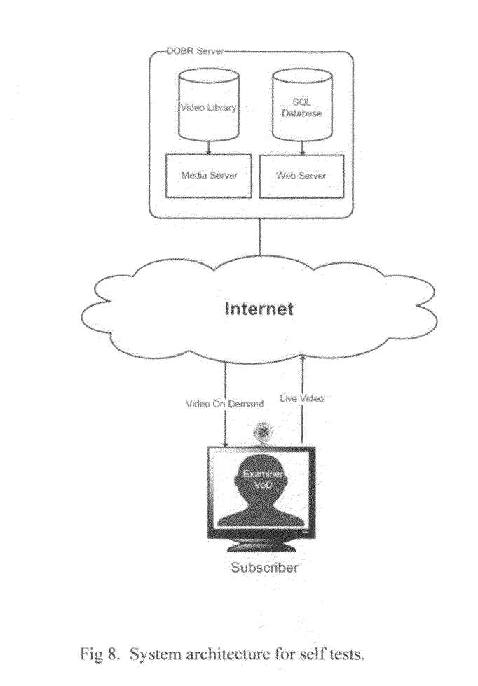

The third approach is the fully interactive subscriber-to-examiner mock examination. The subscriber-to-examiner approach matches a subscriber to a certified professional, such as a board-certified anesthesiologist or board-certified radiologist, who will conduct a real-time oral examination online, in a fully interactive voice-chat environment. This interactive examination takes place through the Web site, with or without outside video-chat services, and will be recorded by the Web site. When a subscriber signs up for a mock examination, they will be assigned an exam topic, such as the “scenario” used in anesthesiology board-certification exams. As depicted in FIG. 3, when the video-chat connection is made through the Web site, a frame of the examiner will appear in the subscriber's screen, and a smaller frame of the subscriber will also appear, allowing the subscriber to view his/her response, both physically and verbally. As a follow-up to the exam, the examiner will submit, through the Web site, an evaluation assessing where the subscriber did well and where the subscriber needs improvement. Both participants will have access to a download of the mock examination, allowing the subscriber to assess strengths and weaknesses in presentation skills. The Web site maintains an on-site listing into which examiners enter their availability by day, date, time and scenario topic. Subscribers, using the same listing feature, can select the time-slot that best suits their schedule. A short time before the exam, a copy of the root question (s), such as a “scenario” used in anesthesiology oral examinations, will then be sent to the subscriber, so that they may prepare for the exam, much as it is done for the real oral examinations. With subscriber permission, these examinations will be stored at the Web site, creating a library of mock examinations to be viewed by other subscribers. As with other video-chat features, the mock examination may be conducted with or without outside video-chat services.

The fourth interactive approach is the subscriber self-test. As depicted in FIG. 4, a copy of a root topic, for example a “scenario” in the field of anesthesiology, appears on the screen. The subscriber will have a brief interval to type their thoughts and responses into a notepad containing a pre-set outline that appears on the screen. After the appropriate interval, a pre-recorded video of an examiner appears on screen. A screen of the subscriber also appears. Adjacent to these viewing areas is a notepad, into which the subscriber can type notes from a keyboard connected to his/her computer, mobile device, television or set-top box. The pre-recorded examiner video is controlled by standard video controls in the viewing area. The subscriber can control the pre-recorded examiner questions by clicking onscreen controls such as “play,” “pause,” “stop” and “next question.” The subscriber is equipped with his/her own webcam.

Thus it will be appreciated by those skilled in the art that the present invention is not restricted to the particular preferred embodiments described with reference to the drawings, and that variations may be made therein without departing from the scope of the present invention as defined in the appended claims and equivalents thereof.

What is claimed is:

1. A fully interactive Web-based distance learning software application, comprising: a browser-based software configuration that requires no software download to users' computers, mobile platforms, televisions or set-top boxes; a browser-based software configuration that allows real-time video-chat with or without outside video-chat services; and a site-based software configuration that allows video-chat encounters to be recorded, stored at the Web site, and downloaded to users' computers, mobile platforms, televisions and set-top boxes at distant and remote locations.

2. A fully interactive Web-based distance learning software application according to claim 1, wherein said software application includes a library of instructional videos, with interactive note-taking capability, and on-screen controls, that can be streamed to users' computers, mobile platforms, televisions and set-top boxes.

3. A fully interactive Web-based distance learning software application according to claim 1, wherein said software application enables video-chat encounters between users at distant and remote locations, with or without outside video-chat services.

4. A fully interactive Web-based distance learning software application according to claim 1, wherein data from said video-chat encounters can be recorded and stored at the Web site, and, then, viewed at the Web site or distributed to users' computers, mobile platforms, televisions and set-boxes at distant and remote locations.

5. A fully interactive Web-based distance learning software application according to claim 1, wherein said software application enables users to self-test against pre-recorded examinations, in a video-chat environment, with results available for download to the user's computer, mobile platform, television or set-top box.

6. A fully interactive Web-based distance learning software application according to claim 1, wherein said software application can be used to facilitate continuing professional education, such as Continuing Medical Education and Continuing Legal Education, in various professional fields, by means stated in claims 2 through 5.

7. A fully interactive Web-based distance learning software application according to claim 1, wherein said software application can be used to facilitate distance learning in academic grades from elementary school through graduate school by means stated in claims 2 through 5.

8. A fully interactive Web-based distance learning software application according to claim 1, wherein said software application can be used to facilitate preparation for oral examinations necessary for board certification in various professions including medical specialties such as anesthesiology, radiology, psychology, psychiatry, surgery, obstetrics/gynecology, emergency medicine and others.
